(19) United States
(12) Patent Application Publication
(10) Pub. No.: US 2003/0151865 A1
(43) Pub. Date: Aug. 14, 2003

(54) Electrostatic discharge protection circuit

(75) Inventor: Kenji Maio, Tokyo (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/309,138

(22) Filed: Dec. 4, 2002

(30) Foreign Application Priority Data
Feb. 14, 2002 (JP) P2002-036463

(51) Int. Cl. H02H 9/00

(52) U.S. Cl. 361/52

(57) ABSTRACT

Provided is an electrostatic discharge protection circuit for protecting from electrostatic destruction an Integrated Circuit (IC) formed from a CMOS material that is capable of handling high frequencies and can withstand low voltage. The electrostatic discharge protection circuit has NMOS transistors, which are diode-connected transistors oriented in opposite directions, connected in parallel between a ground line and a line connecting an input terminal of the IC and the gate of an NMOS transistor included in an amplifier. The electrostatic discharge protection circuit is highly resistive to a surge voltage without impairment by high-frequency characteristics including noise and signal loss. The size of the IC need not be significantly increased to incorporate the new electrostatic discharge protection circuit, which is also highly cost effective since it requires fewer manufacturing steps to produce.

### BACKGROUND OF THE INVENTION

1. Field of the Invention

The present invention relates to an electrostatic discharge protection circuit for protecting an integrated circuit (hereinafter IC) from electrostatic discharge. More particularly, the present invention is concerned with an electrostatic discharge protection circuit adaptable to a high-frequency signal input stage that inputs a high-frequency signal falling within few gigahertz frequency and that is included in portable telephones or wireless data communication systems.

2. Description of the Related Art

In general, a receiving circuit to be included in a portable telephone or a wireless data communication system has the configuration shown in FIG. 1. Namely, a high-frequency signal falling within few gigahertz frequency and received through an antenna 1 is transferred to an impedance matching circuit 3 over a transmission line 2, and amplified by a low-noise amplifier 4. The resultant signal is multiplied by a high-frequency signal, which is produced by a local oscillator 6, by means of a mixer 5, and thus converted into a signal falling within a megahertz frequency band. Thereafter, a desired frequency component alone is amplified by means of a filter 7 and an amplifier 8, digitized by an A/D converter 9, and then demodulated by a digital demodulator 10.

The most important specification for the portable telephone or wireless data communication system is a signal-to-noise ratio. The matching circuit 3 consists mainly of inductors and capacitors that hardly generate a noise. Therefore, the signal-to-noise ratio is often determined by the property of the low-noise amplifier 4. Normally, a noise permitted by the amplifier 4 depends on a purpose of use of the amplifier 4. Assuming that the amplifier 4 is included in a short-distance radio access system, the permissible noise ranges from less than 0.5 to 1 nV/(Hz)^{1/2} and is converted into an equivalent noise resistance of several tens of ohms or less.

Recently, the circuit elements starting with the low-noise amplifier 4 and ending with the demodulator 10 are often integrated into a CMOS IC. A common-source amplifier is known as one form of a CMOS low-noise amplifier. For example, the common-source amplifier is described in “RF Microelectronics” written by Razabi (Prentice Hall PTR, pp.166-181).

FIG. 2 shows an example of the circuitry having a typical high-frequency low-noise common-source amplifier that is fabricated into an IC together with an electrostatic discharge protection circuit. Referring to FIG. 2, there are shown an input pad 21 of an IC, an electrostatic discharge protection circuit 22, a common-source amplifier 23, and an output terminal 24 leading to the next stage. The common-source amplifier 23 is composed of an n-channel MOSFET (hereinafter an NMOS transistor) 231 and a load resistor 232.

Normally, the NMOS transistor 231 deals with high-frequency signals and is fabricated by utilizing a submicron CMOS manufacturing process. The breakdown voltage of such a MOS transistor decreases. For example, the breakdown voltage of a MOSFET fabricated to have sides ranging in length from 0.13 μm to 0.18 μm is between about 1.5 to 2 V. Moreover, the electrostatic discharge protection circuit 22 is used to protect an IC from a surge voltage that is an impulse having several hundreds to several thousands of volts. The surge voltage is applied when a charged human being or machine touches an input/output terminal of the IC.

Consequently, the electrostatic discharge protection circuit 22 should be realized with a circuit that causes a low noise and highly successfully suppresses a surge voltage. Furthermore, the circuit should produce a small grounded capacitance from the viewpoint of minimizing a loss suffered by a high-frequency signal. The present-invention has been completed in efforts to satisfy these requirements.

As an example of a known electrostatic discharge protection circuit, for example, JP-A No. 37284/1996 (which shall be called related art 1) describes a circuit shown in FIG. 3. Referring to FIG. 3, there are shown an input terminal 31 of an IC, an inverter 32, and an electrostatic discharge protection circuit 33. The inverter 32 is composed of a p-channel MOSFET (hereinafter a PMOS transistor) 321 and an NMOS transistor 322. The electrostatic discharge protection circuit 33 is composed of a protective resistor 331, and a PMOS transistor 332 and an NMOS transistor 333 which are diode-connected transistors.

Herein, the threshold voltage (hereinafter threshold voltage Vth) of the NMOS transistor 333 is set to a value equal to or higher than a supply voltage. In the electrostatic discharge protection circuit, if a positive surge voltage exceeding the supply voltage is applied to the input terminal, the NMOS transistor 333 conducts to absorb a surge current. In contrast, if a negative surge voltage is applied, the PMOS transistor 332 conducts to absorb a negative surge current. Consequently, the inverter 32 will not suffer from an overvoltage.

Another electrostatic discharge protection circuit realized with a high-frequency circuit that does not include the above MOS transistors which are diode-connected transistors is described in JP-A No. 18245/1997 (which shall be called related art 2). As shown in FIG. 4, the circuit of related art 2 comprises a signal input terminal 41, an impedance matching circuit 42, a band-pass filter 43, and a gate biasing microstripline 44 for an amplification field-effect transistor (FET) 45. The impedance matching circuit 42 is composed of a microstripline 421 and a capacitor 422 and matches the impedance of a load with that of a signal source. Moreover, the band-pass filter 43 is composed of capacitors 431 and 432 and a microstripline 433. The band-pass filter 43 passes a signal alone but blocks certain frequency components including a surge voltage.

Assume that an attempt is made to adapt the electrostatic discharge protection circuit 33 shown in FIG. 3 and described as related art 1 to the electrostatic discharge protection circuit 22 that serves as an input stage in the common-source amplifier shown in FIG. 2 and that is described previously. This poses problems described below.

First, since the protective resistor 331 is connected in series with a signal path, a thermal noise occurs. The thermal noise Vn per unit frequency band caused by a resistor R is provided as the formula (1) below.

Vn=(4kTR)^{1/2} (1)

where k denotes a Boltzmann's constant and T denotes an absolute temperature.

For example, when the resistor has 1 kΩ, the thermal noise Vn is provided as approximately 4 nV/(Hz)^{1/2} and is too large for an amplifier. In short, an electrostatic discharge protection circuit having a resistor included in a signal path cannot be adapted to an input stage in a low-noise amplifier for portable telephones or the like.

Secondly, the NMOS transistor 333 must be realized with an NMOS transistor whose threshold voltage Vth is different from that of the NMOS transistor 322 included in a main circuit (inverter 32 in FIG. 3). This necessitates addition of an extra manufacturing process, and leads to an increase in the cost of manufacture.

Thirdly, when the manufacturing process is controlled so that the threshold voltage of the NMOS transistor 333 will be equal to or higher than a supply voltage, if a resistance the parasitic resistor produces when an NMOS transistor is turned on is taken account, a suppression voltage required to suppress an applied positive surge voltage becomes a supply voltage Vdd plus alpha. The magnitude of alpha is predicted to reach several volts, though it depends on the particular case. Therefore, the suppression voltage exceeds the gate breakdown voltage of a MOS transistor.

Fourthly, in order to suppress a surge voltage, which ranges from several hundreds of volts to several thousands of volts, to 1 to 2 V or less, a large MOS diode transistor is needed because of the necessity of minimizing the resistance a parasitic resistor produces when a protective MOS diode transistor is turned on. In this case, the parasitic capacitance between the signal line and the ground line increases and a loss suffered by a high-frequency signal increases.

Moreover, the electrostatic discharge protection circuit shown in FIG. 4 and described as related art 2 is supposed to be composed of discrete parts. When an attempt is made to realize the electrostatic discharge protection circuit in the form of an IC, problems described below ensue.

First, in order to include a microstripline in an IC, the IC must be large in size. This is unfeasible in terms of the cost of manufacture.

Secondly, a surge voltage is applied to capacitors 422, 431, and 432. When an IC is fabricated through a microscopic CMOS manufacturing process, the breakdown voltage of a capacitor included in the IC normally ranges from about 2 V to about 10 V. The capacitor will therefore be destroyed.

In both related arts 1 and 2, when an IC is supposed to be fabricated through the microscopic CMOS manufacturing process, there are problems that must be overcome in order to adopt the electrostatic discharge protection circuit as an input stage in a high-frequency low-noise amplifier. Furthermore, a combination of the related arts has not been disclosed or suggested yet. Related art 2 that employs a band-pass filter excludes a protective diode.

### SUMMARY OF THE INVENTION

Accordingly, it would be desirable to provide an electrostatic discharge protection circuit capable of being adopted as an input stage in a high-frequency low noise amplifier that is fabricated through a microscopic manufacturing process.

An electrostatic discharge protection circuit in accordance with the present invention preferably comprises a line on which the pad of an IC and the input terminal of an internal amplifier are connected directly to each other, and complementary diodes that are two diodes connected in parallel with each other between the line and a ground line and oriented in opposite directions.

Another electrostatic discharge protection circuit in accordance with the present invention may have a high-pass filter connected between the pad of an IC and the input terminal of an internal amplifier. Otherwise, the complementary diodes and high-pass filter may be included in combination.

Consequently, an electrostatic discharge protection circuit highly resistive to a surge voltage can be realized.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a block diagram showing an example of the configuration of a typical wireless data communication system;

FIG. 2 is a circuit diagram showing a major portion of an IC that has been discussed previously and into which a typical common-source amplifier is fabricated together with an electrostatic discharge protection circuit;

FIG. 3 is a circuit diagram showing an example of a conventional electrostatic discharge protection circuit;

FIG. 4 is a circuit diagram showing another example of a conventional electrostatic discharge protection circuit;

FIG. 5 is a circuit diagram showing a major portion of a first preferred embodiment of an electrostatic discharge protection circuit in accordance with the present invention;

FIG. 6 is a circuit diagram showing a major portion of a second preferred embodiment of an electrostatic discharge protection circuit in accordance with the present invention;

FIG. 7 is a sectional view showing an example of a capacitor included in an IC and employed in the electrostatic discharge protection circuit shown in FIG. 6;

FIG. 8A is a top view showing an example of an inductor included in an IC and employed in the electrostatic discharge protection circuit shown in FIG. 6;

FIG. 8B is a sectional view showing the example of the inductor included in an IC and employed in the electrostatic discharge protection circuit shown in FIG. 6; and

FIG. 9 is a circuit diagram showing a major portion of a third preferred embodiment of an electrostatic discharge protection circuit in accordance with the present invention.

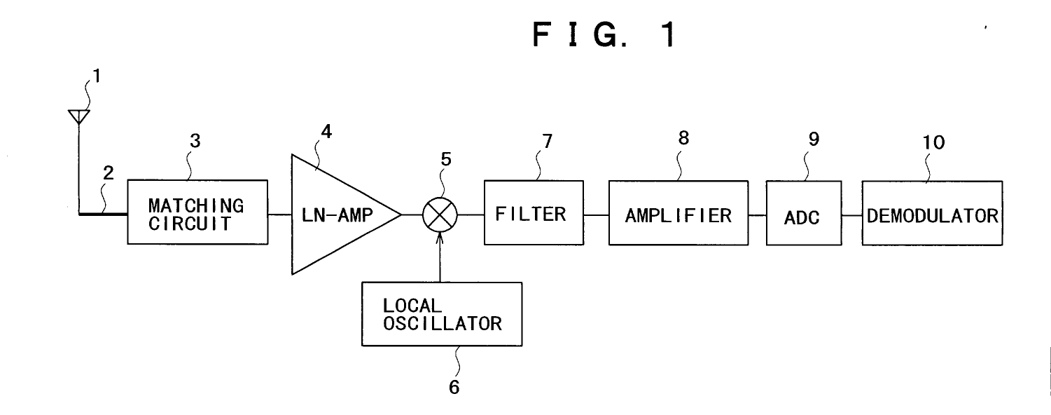

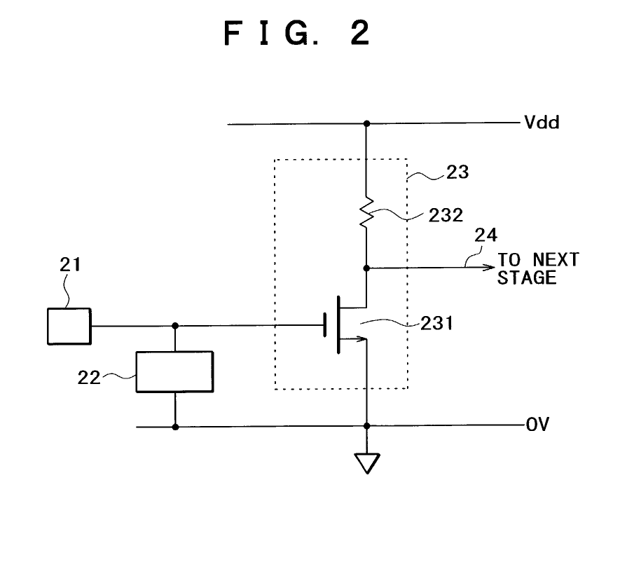

### DETAILED DESCRIPTION OF THE INVENTION

Preferred embodiments of an electrostatic discharge protection circuit in accordance with the present invention will be described with reference to the appended drawings below.

First Preferred Embodiment

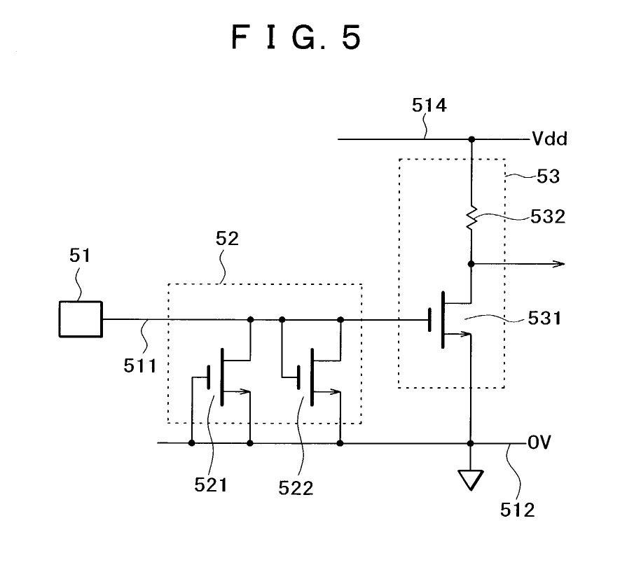

FIG. 5 is a circuit diagram showing a first preferred embodiment of an electrostatic discharge protection circuit in accordance with the present invention. Referring to FIG. 5, there is shown an input pad 51 of an IC. The input pad 51 of the IC is directly connected to a common-source NMOS transistor 531 included in a low-noise amplifier 53 over a line 511. An electrostatic discharge protection circuit 52 is connected between the line 511 and a ground line 512. The electrostatic discharge protection circuit has NMOS transistors 521 and 522, which are diode-connected transistors, connected in parallel with each other and oriented in opposite directions (two diodes thus connected in parallel with each other shall be referred to as complementary diodes) The drain of the common-source NMOS transistor 531 included in the low-noise amplifier 53 is connected onto a power line 514, which develops a supply voltage Vdd, via a load resistor 532.

In the above circuitry, when a positive surge voltage is applied to the input pad 51 of the IC, the NMOS transistor 522 included in the electrostatic discharge protection circuit 52 conducts. When a negative surge voltage is applied, the NMOS transistor 521 conducts. Thus, the positive or negative surge current is absorbed, and the voltage applied to the gate of the NMOS transistor 531 is suppressed, thereby protecting the NMOS transistor 531 from either a positive or negative surge current.

Herein, the NMOS transistors 521, 522, and 531 can be fabricated through the same manufacturing process for the reason described below. Namely, during normal operation, a dc voltage required to deliver an appropriate direct bias current to the NMOS transistor 531 and a high-frequency signal of several tens of millivolts superposed on the direct bias current are applied to the input pad 51. At this time, a bias current flows into the NMOS transistor 522 according to the ratio of the size of the NMOS transistor 522 to the size of the NMOS transistor 531. The flow of the bias current can be suppressed by appropriately determining the ratio of the sizes. Moreover, the amplitude of the high-frequency signal is so small that the NMOS transistors included in the protection circuit 52, or especially, the NMOS transistor 522 will not be fully turned on.

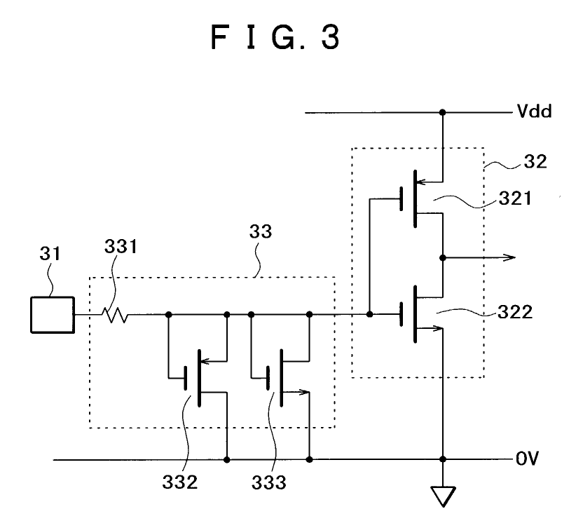

According to the present invention, compared with related art 1 shown in FIG. 3, occurrence of a noise can be suppressed because the protective resistor is unused. Moreover, the surge voltage can be suppressed to a value nearly equal to the threshold voltage Vth (normally about 0.5 V) of NMOS transistors, and will therefore not largely exceed the supply voltage Vdd. Furthermore, a special manufacturing process need not be added for fabricating protective MOS transistors that serve as complementary diodes. Thus, the present preferred embodiment is advantageous in terms of performance and the cost of manufacture.

Junction diodes, bipolar transistors that are diode-connected transistors, PMOS transistors that are diode-connected transistors, or a combination thereof preferably may also be adopted on behalf of the NMOS transistors 521 and 522. In addition, each or both of the diode-connected transistors 521, 522 preferably may comprise two or more NMOS transistors connected in series between the lines 511 and 512.

Second Preferred Embodiment

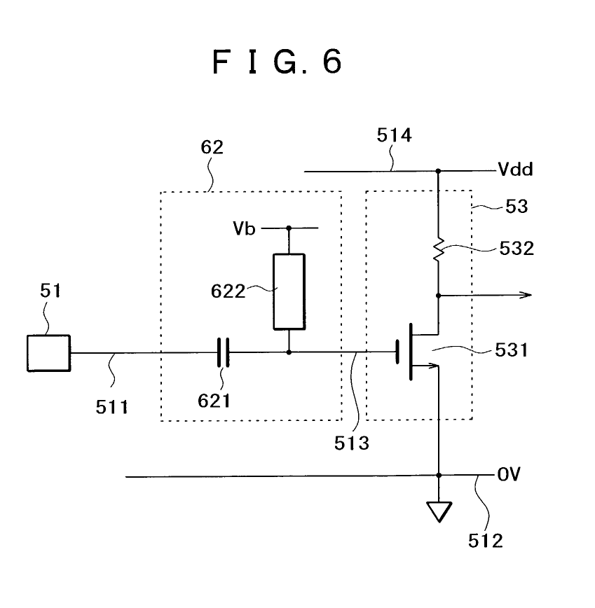

FIG. 6 is a circuit diagram showing a second preferred embodiment of an electrostatic discharge protection circuit of the present invention. In FIG. 6, the same reference numerals are assigned to circuit elements identical to those shown in FIG. 5. Descriptions of the circuit elements identical to those shown in FIG. 5 have been omitted. The electrostatic discharge protection circuit 62 of this preferred embodiment is connected between the input pad 51 of the IC and the amplifier 53, and realized with a high-pass filter comprises a capacitor 621 and an inductor 622.

One terminal of the capacitor 621 is connected to the IC pad 51 over the line 511. The other terminal of the capacitor 621 is connected to a bias voltage line Vb via the inductor 622 and also connected to the gate of the NMOS transistor 531, which is included in the amplifier 53, over a line 513. The bias voltage Vb is required to deliver an appropriate bias current to the NMOS transistor 531.

Normally, a surge pulse only has a frequency component less than several tens of megahertz. If the cutoff frequency of the high-pass filter is determined to fall within a gigahertz frequency band that includes the frequencies of signals, the surge frequency component can be suppressed to a value that is three or four digits smaller. Consequently, the surge voltage can be set to several volts or less.

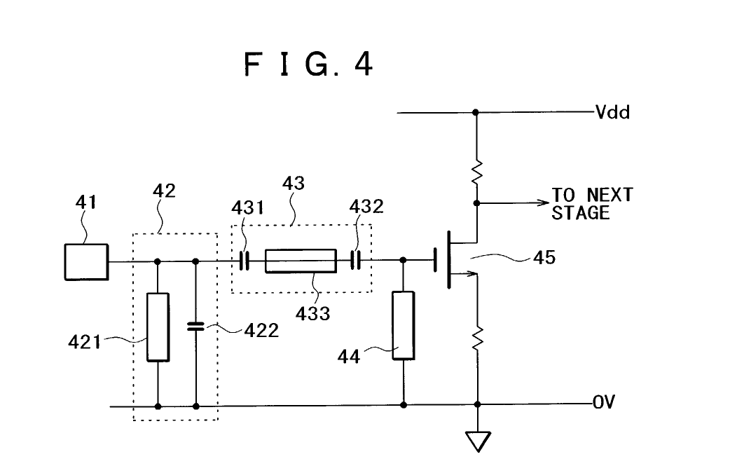

According to this second preferred embodiment, compared with related art 2 shown in FIG. 4, an electrostatic discharge protection circuit can be fabricated in a small size and included in an IC because no microstripline is used. Thus, the second preferred embodiment is markedly advantageous in terms of the cost of manufacture.

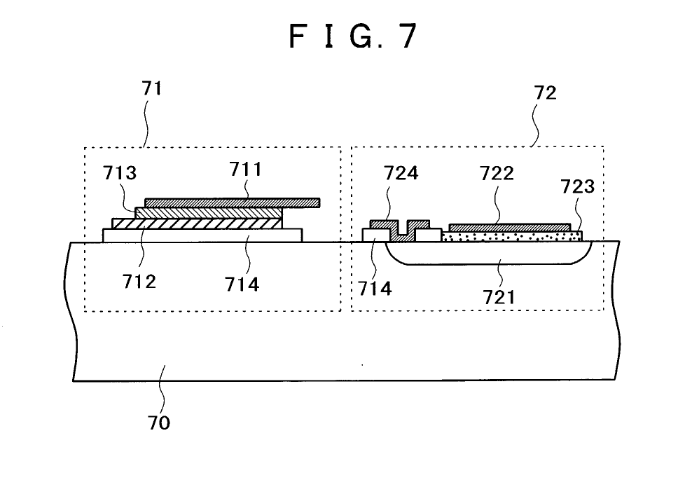

In order to include a capacitor in an IC, for example, as shown in the sectional view of FIG. 7, an MIM capacitor 71 having a dielectric sandwiched between metallic line layers or a MOS gate capacitor 72 is preferably adopted. The MIM capacitor 71 is formed by covering the surface of a dielectric 714, which is formed on a semiconductor substrate 70 based on which an IC is formed, with a metallic line layer 712, and forming a metallic line layer 711 over the metallic line layer 712 with a thin dielectric 713 formed on the metallic line layer 712 between the metallic line layers 711 and 712.

The MOS gate capacitor 72 preferably is constructed utilizing a diffusion layer 721 that is formed in the semiconductor substrate 70, and a polysilicon line layer 722 as upper and lower electrodes, and by utilizing an interlayer gate oxide 723 as a dielectric. The metallic line layer 724 is used as an electrode terminal that enables the diffusion layer 721 to serve as an electrode. Normally, when the electrodes are shaped like a square whose sides are 100 μm long, electrode capacitance ranges from 10 pF to several tens of picofarads.

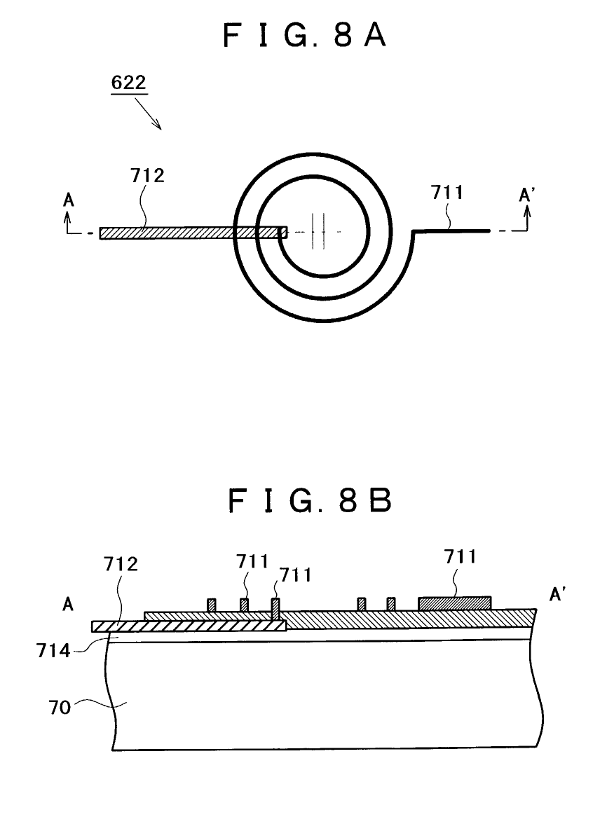

Moreover, the inductor 622, as shown in the top view of FIG. 8A, is preferably constructed by forming a toroid using the metallic line layers. FIG. 8B is a sectional view of the toroid shown in FIG. 8A along line A-A′. As shown in FIG. 8B, the metallic line layer 712 covering the dielectric 714 formed on the semiconductor substrate 70 and the metallic line layer 711 covering the dielectric 713 are used to form the toroidal inductor 622. An inductor whose inductance is several nano-henries is preferably constructed using a coil having two or three windings and a diameter of about 200 μm. In the present preferred embodiment, the high-pass filter 62 comprises the capacitor 621 and the inductor 622. Alternatively, the high-pass filter 62 preferably comprises a capacitor and a resistor.

Third Preferred Embodiment

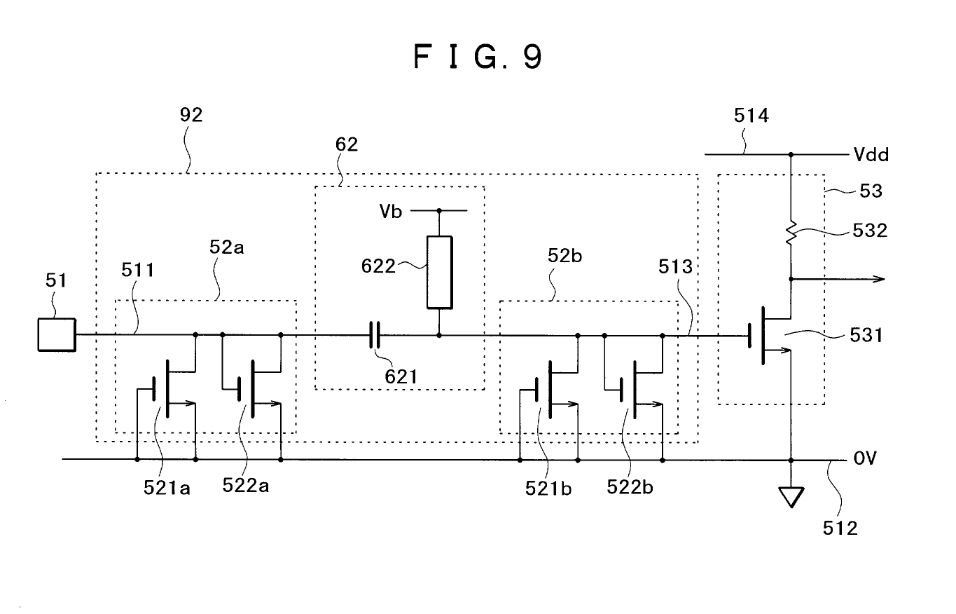

FIG. 9 is a circuit diagram showing a third preferred embodiment of an electrostatic discharge protection circuit. The same reference numerals are assigned to circuit elements identical to those shown in FIGS. 5 and 6. Again, duplicative descriptions of the circuit elements have been omitted.

An electrostatic discharge protection circuit 92 of the present preferred embodiment has, similarly to the one shown in FIG. 6, an electrostatic discharge protection circuit 62 connected between the input pad 51 of the IC and the gate of the NMOS transistor 531 included in the amplifier 53. The electrostatic discharge protection circuit 92 is preferably constructed with a high-pass filter 62 comprising a capacitor 621 and an inductor 622 connected onto a bias voltage line Vb. Furthermore, an electrostatic discharge protection circuit 52a, preferably comprising the complementary diodes 521a and 522a, is connected between the line 511, on which one terminal of the capacitor 621 and the input pad 51 are connected to each other, and the ground line 512. Moreover, a second electrostatic discharge protection circuit 52b, preferably comprising the complementary diodes 521b and 522b, is connected between the line 513, on which the other terminal of the capacitor 621 and the gate of the NMOS transistor 531 are connected to each other, and the ground line 512.

The electrostatic discharge protection circuit 52 comprising complementary diodes is preferably adopted as two stages is to increase the effect of protecting the IC from electrostatic destruction. Alternatively, it would be preferable to employ only the single electrostatic discharge protection circuit 52a disposed near the input pad of the IC. Moreover, a resistor may be substituted for the inductor 622. As another preferred alternative, a serial connected circuit of 2 or more NMOS diodes may be employed instead of NMOS 522b to decrease the bias current.

According to the present preferred embodiment, no protective resistor is interposed between an input pad and an amplification MOS transistor. Therefore, compared with related arts 1 and 2 shown in FIG. 3 and FIG. 4, occurrence of noise is successfully suppressed.

The complementary diodes are preferably fabricated during the same manufacturing process as the amplification NMOS transistor 531 thereby Reducing the number of manufacturing steps required.

The thresholds Vth of the NMOS transistors 521a, 521b, 522a and 522b are sufficiently lower than the supply voltage Vdd. Therefore, the suppression voltage required to suppress an applied surge is reduced.

The combination of complementary diodes and a high-pass filter defuses the effects of protecting the IC from electrostatic discharge exerted by the complementary diodes and high-pass filter, respectively. Consequently, the size of the complementary diodes is reduced, parasitic capacitance is minimized and loss suffered by an input signal is suppressed.

Since no microstripline is used, an electrostatic discharge protection circuit can be fabricated in a small size and included in an IC. This is quite advantageous in terms of the cost of manufacture.

Furthermore, since the complementary diodes are included as a stage preceding the capacitor 621, a surge voltage can be absorbed to some extent. A voltage to be applied to the capacitor can be lowered to several volts or less. Consequently, the capacitor will not be destroyed because of an overvoltage.

As apparent from the aforesaid embodiments, according to the present invention, protection from electrostatic discharge can be achieved without impairment of high-frequency characteristics including occurrence of a noise and a loss of a signal. At the same time, an extra process need not be added and the size of an IC need not be increased greatly. Thus, the present invention is outstandingly cost-effective.

The foregoing invention has been described in terms of preferred embodiments. However, those skilled in the art will recognize that many variations of such embodiments exist. Such variations are intended to be within the scope of the present invention and the appended claims.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered by way of example only to facilitate comprehension of the invention and should not be construed to limit the scope thereof.

What is claimed is:

1. An electrostatic discharge protection circuit comprising:
a line connecting a pad of an integrated circuit and an input terminal of an internal amplifier; and
first and second diode connections, having a plurality of diodes, connected in parallel between said line and a ground line.

2. An electrostatic discharge protection circuit of claim 1 wherein a first diode on said first diode connection is oriented in a first direction and a second diode on said second diode connection is oriented in a second direction opposite to said first direction.

3. An electrostatic discharge protection circuit of claim 1 wherein each of said first and second diode connections connects at least one diode between said line and said ground line.

4. An electrostatic discharge protection circuit of claim 3 wherein one of said first and second diode connections connects at least two diodes in series between said line and said ground line.

5. An electrostatic discharge protection circuit according to claim 1 wherein a high-pass filter is connected between said pad and said input terminal.

6. An electrostatic discharge protection circuit according to claim 5 wherein said first and second diode connections are connected between said ground line and said line between said input pad and an input stage in said high-pass filter.

7. An electrostatic discharge protection circuit of claim 6 wherein a first diode on said first diode connection is oriented in a first direction and a second diode on said second diode connection is oriented in a second direction opposite to said first direction.

8. The electrostatic discharge protection circuit of claim 6 wherein each of said first and second diode connections connects at least one diode between said line and said ground line.

9. An electrostatic discharge protection circuit of claim 8 wherein one of said first and second diode connections connects at least two diodes in series between said line and said ground line.

10. An electrostatic discharge protection circuit comprising:
a high-pass filter interposed between a pad of an integrated circuit and an input terminal of an internal amplifier; and
first and second diode connections, having a plurality of diodes, connected in parallel between a first line connecting said pad and an input stage in said high-pass filter, and a ground line, and third and fourth diode connections, having a plurality of diodes, connected in parallel between a second line connecting an output stage in said high-pass filter and said input terminal, and said ground line.

11. An electrostatic discharge protection circuit of claim 10 wherein a first diode on said first diode connection is oriented in a first direction and a second diode on said second diode connection is oriented in a second direction opposite to said first direction, and wherein a third diode on said third diode connection is oriented in said first direction and a fourth diode on said fourth diode connection is oriented in said second direction.

12. An electrostatic discharge protection circuit of claim 10 wherein each of said first and second diode connections connects at least one diode between said first line and said ground line, and wherein each of said third and fourth diode connections connects at least one diode between said second line and said ground line.

13. An electrostatic discharge protection circuit of claim 12 wherein one of said first and second diode connections connects at least two diodes in series between said first line and said ground line, and wherein one of said third and fourth diode connections connects at least two diodes in series between said second line and said ground line.

14. An electrostatic discharge protection circuit according to claim 5 wherein said high-pass filter comprises a capacitor connected between said pad and said input terminal, and an inductor wherein a first end of said inductor is connected on said line between said capacitor and said input terminal and a second end of said inductor is connected to a bias voltage line.

15. An electrostatic discharge protection circuit according to claim 14 wherein said high-pass filter includes a resistor in place of said inductor.

16. An electrostatic discharge protection circuit according to claim 1 wherein each of said plurality of diodes comprises a bipolar transistor that is a diode-connected transistor having a base thereof connected to a collector thereof.

17. An electrostatic discharge protection circuit according to claim 1 wherein each of said plurality of diodes comprises a MOS transistor that is a diode-connected transistor having a gate, thereof connected to a drain thereof.

18. An electrostatic discharge protection circuit comprising:
a line connecting a pad of an integrated circuit and an input terminal of an internal amplifier; and
first and second diode connections connected in parallel between said line and a ground line, wherein said first diode connection connects a first diode oriented in a first direction between said line and said ground line, and said second diode connection connects a first plurality of diodes, oriented in a second direction opposite to said first direction, in series between said line and said ground line.

19. An electrostatic discharge protection circuit according to claim 18 further comprising:
a high-pass filter interposed on said line between said pad and said input terminal, wherein said first and second diode connections are connected to said line between said pad and an input stage in said high-pass filter.

20. An electrostatic discharge protection circuit according to claim 19 further comprising:
third and fourth diode connections connected in parallel between said ground line and said line between an output stage in said high-pass filter and said input terminal, wherein said third diode connection connects a second diode oriented in said first direction between said line and said ground line and said fourth diode connection connects a second plurality of diodes, oriented in said second direction, in series between said line and said ground line.
